(19) United States
(12) Patent Application Publication
(10) Pub. No.: US 2012/0237743 A1
(43) Pub. Date: Sep. 20, 2012

(54) Reinforced Multi-Layer Polymeric Films and Methods of Forming Same

(76) Inventors: Hugh Joseph O'Donnell, Cincinnati, OH (US); Daniel Charles Peck, Cincinnati, OH (US); Pier-Lorenzo Caruso, Frankfurt am Main (DE)

(21) Appl. No.: 13/421,070

(22) Filed: Mar. 15, 2012

Related U.S. Application Data
(60) Provisional application No. 61/454,132, filed on Mar. 18, 2011.

(51) Int. Cl. B32B 7/02; B29C 47/06

(52) U.S. Cl. 428/213; 264/176.1; 264/210.1

(57) ABSTRACT

A multi-layer film that includes at least one polymeric skin layer and polymeric “A” layer is provided. The polymeric “A” layer is formed from a composition that includes a soft or base polymer matrix and a hard polymer substantially disposed therein to form a reinforcing structure in the polymer matrix. The multi-layer film may also include a polymeric “B” layer that has a hard polymer substantially disposed therein. Methods of forming a multi-layer film are also provided.

### CROSS-REFERENCE TO RELATED APPLICATIONS

This application claims the benefit of U.S. Provisional patent application Ser. No. 61/454,132, filed Mar. 18, 2011; and U.S. patent application Ser. No. 13/084,630, filed Apr. 12, 2011.

### TECHNICAL FIELD

The present disclosure generally relates to multi-layer polymeric films and methods of forming the same.

### BACKGROUND

Many products today require highly engineered components and yet, at the same time, these products are required to be limited use or disposable items. By limited use or disposable, it is meant that the product and/or component is used only a small number of times or possibly only once before being discarded. Examples of such products include, but are not limited to, personal care absorbent products such as diapers, training pants, incontinence garments, sanitary napkins, bandages, wipes and the like, as well as products such as packaging materials, and other disposable products such as trash bags and food bags. These types of products can and do utilize films. When films are used in limited use and/or disposable products, the impetus for maximizing engineered properties while reducing cost is extremely high.

In the area of films, there have been previous attempts to make multi-layer films having reduced thicknesses and certain opacifying characteristics. For example, U.S. Pat. No. 5,261,899 to Visscher describes a three layer film made with a central layer that comprises from about 30% to 70% of the total thickness of the multi-layer film. One advantage in forming multi-layer films is that specific properties can be designed into the film, and, by making the films multi-layer, the more costly ingredients can be relegated to the layers where they are most likely to be needed. Such films may also contain fillers for various purposes, including, for example, opacifying films.

By utilizing light refracting fillers, which have a refractive index different than that of the polymeric material in the film layer, an opaque film can be produced without stretching of the film as part of the manufacturing process. The pigmentation results from the scattering of light rays refracted from fillers and not as a result of voids created by stretching of film. Titanium dioxide, zinc oxide, and zinc sulphide work well with the polymeric materials to form the film layer and cause opacification by light refraction. Filler films are also disclosed in U.S. Pat. No. 4,116,892.

However, many of these films have performance limitations. The incorporation of fillers into films may lead to diminished properties such as tensile strength and yield stress. Therefore, the search continues for improved multi-layer polymeric films and methods for making the same. In particular, it would be desirable to have higher performance, lower cost multi-layer polymeric films. Higher performance includes providing multi-layer films with lower basis weights that are not brittle and do not tear easily.

Furthermore, some consumers display an aversion to purchasing products that are derived from petrochemicals. In such instances, consumers may be hesitant to purchase products made from limited non-renewable resources such as petroleum. Other consumers may have adverse perceptions about products derived from petrochemicals being “unnatural” or not environmentally friendly.

Accordingly, it would be desirable to provide a multi-layer polymeric film which comprises lower basis weight reducing the use of petroleum and lowering costs and potentially enabling the affordable use of non-petroleum source resins, where the multi-layer polymeric film has improved performance characteristics to satisfy product and/or packaging needs.

### SUMMARY

The present disclosure generally relates to multi-layer polymeric films and methods of forming the same.

In one embodiment, the multi-layer polymeric film comprises
a) at least one outer polymeric skin layer; and
b) a first polymeric layer, or “A” layer, joined to the skin layer, the “A” layer comprising a first composition comprising a first polymer matrix and about 5 to about 40 volume percent of a first hard immiscible polymer substantially disposed in the first polymer matrix to form a structure in the polymer matrix,
   wherein the skin layer has a thickness that is from about 20 to about 60% of the thickness of the multi-layer polymeric film.

In other embodiments, the multi-layer polymeric film may have two outer surfaces, each comprising an outer polymeric skin layer. The multi-layer film may further include a second polymeric layer, or “B” layer that has a second hard immiscible polymer substantially disposed therein. The “A” layer and the “B” layer may be adjacent to each other and differ in at least one of the following: the first polymer matrix and the second polymer matrix are different; the first hard immiscible polymer and the second hard immiscible polymer are different; and/or the volume fraction of the first hard immiscible polymer in the “A” layer is different than the volume fraction of the second hard immiscible polymer in the “B” layer. In embodiments in which there is an “A” layer and a “B” layer, there can be multiple “A” layers and “B” layers. If there are multiple “A” layers and “B” layers, the “A” and “B” layers may alternate. Numerous additional layer arrangements are possible.

In some embodiments, at least one of the first material and the second material may provide void-initiating properties when the multi-layer film is stretched. In some cases, one of the first material and the second material may provide void-initiating properties when the multi-layer film is stretched, and the other of the first and second material may form a microscopically separate and distinct polymeric solid phase, but need not provide void-initiating properties when the film is stretched.

A method of forming a multi-layer polymeric film is also provided. In one embodiment, the method comprises preparing a first composition, preparing a second composition, preparing a third composition, and co-extruding the first composition, second, and third compositions. The first composition comprises a first base polymer and a first hard polymer that is immiscible in the first base polymer, and has a higher elastic modulus than the first polymer. The second composition comprises a second base polymer and a second hard polymer that is immiscible in the second base polymer, and has a higher elastic modulus than the second base polymer. The third composition comprises a polymer, and may be substantially free of hard polymers. The compositions are formed into a layer arrangement in which the first and second compositions form adjacent layers, and the third composition forms a skin layer forming one of the outer surfaces of the multi-layer polymeric film. After the layers are formed, the first hard polymer is substantially disposed in the first layer and the second hard polymer is substantially disposed in the second layer. In some embodiments, each alternating layer may differ in at least one of the following: the first polymer and the second polymer are different; the first hard polymer and the second hard polymer are different; or, there is a difference in concentration of the first and second hard polymers in the respective first and second polymers. After the film is formed, if desired, the film may be stretched. Stretching may be used for various purposes including, but not limited to initiating micro voids, and/or improving various properties of the film, such as opacity.

### BRIEF DESCRIPTION OF THE DRAWINGS

FIG. 1 is a schematic representation of a multi-layer polymeric film having three layers, wherein the central layer includes a hard polymer.

FIG. 2 is a schematic representation of a multi-layer polymeric film having five layers, wherein the central three layers include hard polymers.

FIG. 3 is a photomicrograph taken from an atomic force microscopy image showing a cross-sectional view of a non-activated multi-layer polymeric film having at least some inclusion material in each of the layers, looking into the film from the machine direction.

FIG. 4 is a cross-sectional view of the film shown in FIG. 3, shown looking into the film from the cross-machine direction.

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the absence of particular elements in any of the exemplary embodiments, except as may be explicitly delineated in the corresponding written description. The drawings are not necessarily to scale.

### DETAILED DESCRIPTION

### I. Definitions

As used herein, the following terms shall have the meaning specified thereafter:

“Bio-based content” refers to the amount of carbon from a renewable resource in a material as a percent of the mass of the total organic carbon in the material, as determined by ASTM D6866-10, method B. Note that any carbon from inorganic sources such as calcium carbonate is not included in determining the bio-based content of the material.

“Cavitation” refers to formation of voids within a layer or multiple layers of a film due to activation/stretching of the film.

“Hard polymers” refers to polymers having an elastic modulus at least 30% higher than the elastic modulus of the respective base polymer.

In the context of the present disclosure, “immiscible” and/or “incompatible” refers to microscopically separate and distinct polymeric solid phases of different polymers. The phases retain their individual glass transition temperatures and these temperatures are not modified or changed by the presence of the other polymer. These distinct microscopic solid phases differentially strain upon deformation.

“Renewable resource” refers to a natural resource that can be replenished within a 100 year time frame. The resource may be replenished naturally, or via agricultural techniques. Renewable resources include plants, animals, fish, bacteria, fungi, and forestry products. They may be naturally occurring, hybrids, or genetically engineered organisms. Natural resources such as crude oil, coal, and peat which take longer than 100 years to form are not considered to be renewable resources.

The phrase “substantially disposed therein”, as used herein, includes structures in which the inclusion (such as the hard polymer) is located entirely within a layer, and also those in which the inclusion may extend at least partially into an adjacent layer or layers.

Unless otherwise stated, whenever the percentage of a layer that is occupied by an inclusion is described herein, the percentage refers to volume percent, or volume fraction. Volume fraction of a material is calculated in the normal means from standard temperature component densities (ρᵢ) and mass fractions (mᵢ). For example, when formulating for a two component system (from components 1 and 2) at standard temperature, the volume fraction for component 1 can be calculated with the equation below:

$${v}_{f 1} = \frac{{m}_{1} / {ρ}_{1}}{( {m}_{1} / {ρ}_{1} + {m}_{2} / {ρ}_{2} )}$$

The terms “standard conditions” or “standard temperature”, as used herein, refer to a temperature of 77° F. (25° C.) and 50% relative humidity. When the formula is not available, the volume fraction of a film can be calculated by averaging two dimensional cross-section images of films using standard stereology techniques as described in C. Maestrini, M. Merlotti, M. Vighi and E. Malaguti, Second phase volume fraction and rubber particle size determinations in rubber-toughened polymers: A simple stereological approach and its application to the case of high impact polystyrene, Journal of Materials Science, 27(22), 5994-6016.

The present invention is directed toward multi-layer films and methods of making the same. The films may have a lower basis weights, and/or improved mechanical properties than films, for example, such as those made of the same matrix polyolefin compositions without the immiscible structures therein. In certain embodiments, the structures may, thus, serve as reinforcing structures.

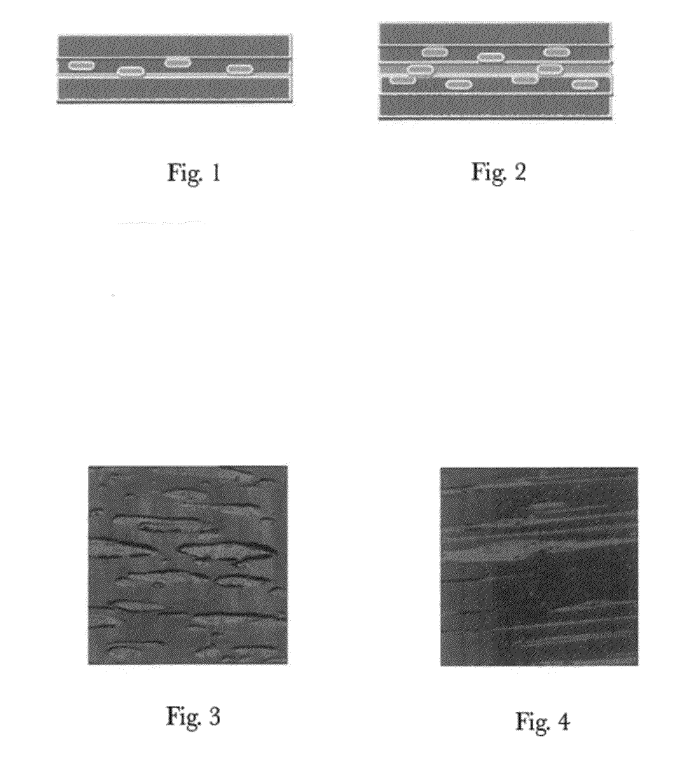

FIG. 1 shows that in one embodiment, the multi-layer film 20 comprises two skin or “S” layers and an “A” layer therebetween that includes an immiscible hard polymer. Each skin layer forms one of the outer surfaces of the multi-layer film 20. Each of the layers described herein has two opposed surfaces. The surfaces may be referred to herein as a first (or “upper”) surface and a second (or “lower”) surface. It is understood, however, that the terms “upper” and “lower” refer to the orientation of the multi-layer film shown in the drawings for convenience, and that if the film is rotated, these layers will still bear the same relationship to each other, but an upper layer may be a lower layer and a lower layer may be an upper layer after the film is rotated. The layers are arranged so at least one surface of a layer is joined to the surface of another layer.

The skin layer(s), S, can serve any suitable function. Such functions may include, but are not limited to controlling the overall concentration of immiscible hard polymer in the multi-layer film 20 (so that the multi-layer film has the desired properties, e.g., softness, etc.) The skin layer(s) may also serve to provide stability during extrusion, and/or provide the multi-layer film with improved properties, such as better bonding to other materials. The skin layer(s) are polymeric, and may comprise any of the materials described herein as being suitable for use as the base polymers in the “A” layer. The skin layers may, thus, be comprised of polyolefin resins. The skin layer(s), however, may be substantially free, or completely free, of immiscible hard polymers. The skin layer(s) may have a total thickness (that is, combined thickness, if more than one) that is from about 20% to about 60% of the thickness of the multi-layer polymeric film.

The “A” layer of the multi-layer polymeric film comprises a base or matrix polymer. The base polymer is capable of being formed into a film, and will form a matrix in which the immiscible hard polymer described herein is substantially disposed. The immiscible hard polymer may form at least one structure in the “A” layer. In some cases, the structure(s) may serve as a reinforcing structure for the layer containing the structure, and as a reinforcing structure for the multi-layer film 20. Examples of such structures may be in the form of a ribbon, fibril, or platelet. The structure(s) may comprise high aspect ratio structures, such as those having an aspect ratio greater than or equal to about 2, 5, 10, 15, or 20 up to about 100, or more.

The multi-layer film may further include a second polymeric layer, or “B” layer comprising a second base polymer that has a second hard immiscible polymer substantially disposed therein. The “A” layer and the “B” layer may be adjacent to each other and differ in at least one of the following: the first polymer matrix and the second polymer matrix are different; the first hard immiscible polymer and the second hard immiscible polymer are different; and/or the volume fraction of the first hard immiscible polymer in the “A” layer is different than the volume fraction of the second hard immiscible polymer in the “B” layer.

In any of these embodiments, additional A and B layers can be included in the film. The A and B layers can be arranged in layered relation relative to each other (e.g., FIG. 1) or in a multiple, repeating layer arrangement (e.g., FIG. 2). The multi-layer polymeric film can comprise “n” number of layers of the A and B layers. Therefore, it is contemplated that multi-layer polymeric films contemplated herein may include additional layers relative to the depictions illustrated in FIGS. 1 and 2. In versions of such embodiments, the film may include three or more repeating contiguous A/B layers which can be disposed in numerous arrangements, including but not limited to: throughout the entire structure; through portions of the film thickness; or distributed in numerous groups within the film. Further, additional layers, which are neither “A” layers nor “B” layers (e.g., one or more “C” layers), may be included in the multi-layer polymeric film. The C layer(s) may be comprised of polymeric or polyolefin resins, and may be included for any suitable purpose, including to further modify the film properties. The multi-layer film may comprise various layer arrangements including, but not limited to any of the following layer arrangements: S/A/B/S; S/A/B/A/S; S/B/A/B/S; S/A/C/A/S; or S/A/B/A/C/A/B/A/S layers.

While FIGS. 1 and 2 generally illustrate various layer arrangements for multi-layer polymeric films, it will be appreciated that such multi-layer polymeric films can comprise from about 2 layers to about 1,000 layers; in certain embodiments from about 3 layers to about 200 layers.

The multi-layer polymeric films contemplated herein can have a thickness from about 4 micrometers to about 100 micrometers, alternatively from about 4 micrometers to about 50 micrometers. The total thicknesses of all of the “A” and “B” layer(s) can comprise about 20 to about 80% of the film thickness. The “A” layer and the “B” layer may each have any suitable thickness including, but not limited to a thickness of greater than or equal to about any of the following: about 50, 100, 200, or 300 nanometers to less than or equal to about 6 micrometers, alternatively less than or equal to about 12 micrometers or more, or any range of thickness between two of these numbers. It will be appreciated that the “A” layer and the “B” layer can have substantially the same thickness, or different thicknesses. In certain embodiments, the ratio of the thickness of “A” layer to the “B” layer, or vice versa, can range from about 1:1.2 to about 1:5, alternatively from about 1:1.5 to about 1:4. The multi-layer films can have a basis weight from about 4 gsm to about 100 gsm, alternatively about 4 gsm to about 50 gsm, or from about 6 gsm to about 18 gsm.

The base polymers in the “A” and “B” layers may include polyolefins, particularly polyethylenes, polypropylenes, polybutadienes, polypropylene-ethylene interpolymers and copolymers having at least one olefinic constituent, and any mixtures thereof. Certain polyolefins can include linear low density polyethylene (LLDPE), low density polyethylene (LDPE), medium density polyethylene (MDPE), high density polyethylene (HDPE), isotactic polypropylene, random polypropylene copolymer, impact modified polypropylene copolymer, heterophasic polypropylenes, and other polyolefins which are described in PCT Application Nos. WO 99/20664, WO 2006/047374, and WO 2008/086539. Other base polymers such as polyesters, nylons, copolymers, thereof, polyhydroxyalkanoates (or PHA's), and combinations of any of the foregoing may also be suitable. In addition, polyolefin plastomers and elastomers could be used to form the multi-layer polymeric films. Examples of such suitable polyolefin plastomers and elastomers are described in U.S. Pat. No. 6,258,308; U.S. Publication No. 2010/0159167 Al; and PCT Application Nos. WO 2006/047374 and WO 2006/017518. In one embodiment, such polyolefin plastomers and/or elastomers may comprise up to 25% by volume of the multi-layer polymeric film. Other useful polymers comprise poly-α-olefins such as those described in PCT Application No. WO 99/20664 and the references described therein.

The base polymer can also comprise materials that provide the film with a bio-based content. Such materials include, but are not limited to materials that are at least partially derived from a renewable resource. Such materials include polymers that are derived from a renewable resource either directly, or indirectly through one or more intermediate compounds. Suitable intermediate compounds derived from renewable resources include sugars (including monosaccharides, disaccharides, trisaccharides, and oligosaccharides). Sugars include sucrose, glucose, fructose, and maltose, as well as those derived from other agricultural products such as starch or cellulose. Other suitable intermediate compounds derived from renewable resources include monofunctional alcohols such as methanol or ethanol and polyfunctional alcohols such as glycerol. Other intermediate compounds derived from renewable resources include organic acids (e.g., citric acid, lactic acid, alginic acid, amino acids etc.), aldehydes (e.g., acetaldehyde), and esters (e.g., cetyl palmitate, methyl stearate, methyl oleate, mono-, di-, and triglycerides, etc.).

Additional intermediate compounds such as methane and carbon monoxide may also be derived from renewable resources by fermentation and/or oxidation processes.

Intermediate compounds derived from renewable resources may be converted directly into polymers (e.g., lactic acid to polylactic acid) or they may be further converted into other intermediate compounds in a reaction pathway which ultimately leads to a polymer useful in a multi-layer film. An intermediate compound may be capable of producing more than one secondary intermediate compound. Similarly, a specific intermediate compound may be derived from a number of different precursors, depending upon the reaction pathways utilized.

Particularly desirable intermediates include olefins. Olefins such as ethylene and propylene may also be derived from renewable resources. For example, methanol derived from fermentation of biomass may be converted to ethylene and or propylene, which are both suitable monomeric compounds, as described in U.S. Pat. Nos. 4,296,266 and 4,083,889. Ethanol derived from fermentation of a renewable resource may be converted into the monomeric compound ethylene via dehydration as described in U.S. Pat. No. 4,423,270. Similarly, propanol or isopropanol derived from a renewable resource can be dehydrated to yield the monomeric compound of propylene as exemplified in U.S. Pat. No. 5,475,183. Propanol is a major constituent of fusel oil, a by-product formed from certain amino acids when potatoes or grains are fermented to produce ethanol.

Charcoal derived from biomass can be used to create syngas (i.e., CO+H₂) from which hydrocarbons such as ethane and propane can be prepared (Fischer-Tropsch Process). Ethane and propane can be dehydrogenated to yield the monomeric compounds of ethylene and propylene.

Other sources of materials to form polymers include post-consumer recycled materials. Sources of post-consumer recycled materials can include plastic bottles, e.g., soda bottles, plastic films, plastic packaging materials, plastic bags and other similar materials which contain synthetic materials which can be recovered.

Such materials that may provide the film with a bio-based content and post-consumer recycled materials are described in U.S. patent application Ser. No. 13/084,630, filed Apr. 12, 2011.

In one embodiment, the base polymer used in the “A” and “B” layers can be substantially the same. For example, the “A” layer and the “B” layer shown in FIG. 2 can comprise the same base polymers. Materials such as LLDPE and MDPE are considered to comprise the same base polymers herein since they both comprise variations of the same polymer, polyethylene. The base polymer (or polymers) used in the respective layers may comprise any suitable volume percentage of the respective layers, such as from about 50 to about 95%, alternatively from about 70% to about 92% by volume of each of the reinforcing layers. If a given layer contains a mixture of two or more base polymers, the volume percentages in the preceding sentence apply to the total amount of all base polymers in the layer. The entire film may contain between about 5 and 15 volume percent hard polymer. In certain embodiments, the LLDPE and the MDPE base polymers can be made into a cast film having a density from about 0.905 g/cm³ to about 0.945 g/cm³, alternatively from about 0.910 g/cm³ to about 0.935 g/cm³. The melt index for such cast films (e.g., LLDPE and MDPE) can be from about 0.8 g/10 min to about 6 g/10 min, alternatively from about 1 g/10 min to about 5 g/10 min. LLDPE and MDPE can also be formed as blown films can have a melt index ranging from about 0.4 g/10 min to about 2 g/10 min.

In another embodiment, the base polymers used in respective adjacent A and B layers can be substantially different. This difference can be described in either mechanical property differences or chemical compositional differences between the base polymer in the “A” layer and the base polymer in the “B” layer. For example, the “A” layer and the “B” layer of FIGS. 1 and 2 could comprise different base polymers such as the “A” layer could comprise LLDPE and the “B” layer could comprise polypropylene homopolymers, or copolymers. It is well known that for polyolefins, comonomer type and molar content can substantially change the mechanical properties and/or polar interaction of their respective polymers. Comonomer types for polyolefins include ethylene, propylene, butene, hexene, octene, styrene, vinyl acetate, methyl acrylate, acrylic acid, maleic anhydride. A substantial difference can include a 30% difference in modulus if the polymeric layers are made into films and the modulus compared. A substantial difference also includes the use of molar percent differences of at least 2 mole percent in the included monomers within the polyolefin polymer. Thus, in some embodiments, the molar percent differences may be about 5 mole percent in the included monomers within the polyolefin polymer.

Furthermore, when selecting base polymers for the respective layers of the multi-layer polymeric film, such layers can be compatible and self-adhering to each other to prevent problems in joining the two or more layers into a substantially continuous, unitary multi-layer polymeric film.

The respective “A” and “B” layers can further comprise an inclusion, in the form of an immiscible hard polymer to provide improved property characteristics to the multi-layer polymeric film. For example, “A” layer and the “B” layer as generally illustrated in FIGS. 1 and 2 could each include a hard polymer. These included hard polymers are contemplated to have a higher elastic modulus than the elastic modulus for the respective base polymers. In certain embodiments, the included hard polymer can have an elastic modulus at least 30%, 50%, 100%, or 200% higher than the elastic modulus of the respective base polymers. These included hard polymers can make up a significant portion of the multi-layer polymeric film. In certain embodiments, the included hard polymer in the “A” and “B” layers can comprise from about 5 to about 40% by volume, alternatively from about 8% to about 30%, by volume of the reinforcing layer. In some embodiments, the volume percentage of the hard polymer may differ in the “A” and “B” layers. For example, in one embodiment, the hard polymer in the A layer may comprise from about 5%-40%, alternatively from about 5%-30% by volume of the A layer; and the hard polymer in the B layer comprises from about 5%-40%, alternatively from about 5%-30% by volume of the B layer. In various embodiments, the first and second hard polymers may exceed the elastic modulus of their respective base polymers by any of the above percentages, and the percentages by which their elastic modulus exceeds that of their respective base polymers, can differ.

The elastic modulus of polymers is measured by the standard technique in ASTM D882 or secondary methods such as secant modulus at 2% measured using the same standard. The secondary methods are used for materials where elastic modulus measurement is difficult as discussed in the standard. Although estimates of the elastic modulus can be obtained using references such as Materials Science of Polymers for Engineers, Osswald and Menges, Hanser Publishing, 1995, Table 1 in appendix, for the purpose of the appended claims, measurements as specified in ASTM D882 shall be used to measure elastic modulus of polymers.

The immiscible void initiating hard polymers can include, but are not limited to: polystyrene, high impact polystyrene, polybutylene terephthalate, polytrimethylene terephthalate, polycarbonate, polylactic acid, polymethyl methacrylate, cellulose acetate, thermoplastic starch, polyhydroxyalkanoates (or PHA's) (provided that the base polymer is not also the same polymer such as PHA), and combinations thereof. It will be appreciated that other hard polymers that can be processed with polyolefins which demonstrate micro-voiding upon suitable stretching can also be useful.

Thermoplastic starch refers to the combination of highly destructured starch and plasticizer. Natural starch is generally granular and does not melt before it degrades thus rendering it non-thermoplastic. Destructuring is the process in which the granular nature of the starch is largely removed through various means including thermal and mechanical and most involve the utilization of water as the destructuring agent. When largely destructured starch is combined with the appropriate plasticizer, the starch/plasticizers system behaves like a thermoplastic and is termed thermoplastic starch.

Starch refers to any starch including natural and or chemically modified. Starch can be derived from wheat, potato, rice, corn, tapioca, cassava, and other origins. Starch is a polysaccharide that contains both linear chains, amylose, and highly branched chains, amylopectin. The chemically modified starches may be reacted with different functional groups and/or cross-linked. The hydroxyl groups in the starch can be substituted to form esters and ethers of varying degree of substitution. Starches can be extended with optional ingredients such as various proteins.

Plasticizers include glycerin, ethylene glycol, ethylene triglycol, propylene triglycol, PEG, PPG, 1-2 propanediol, 1-3 propanediol, 1-2 butanediol, 1-3 butandiol, 1-4 butanediol, 1-5 pentanediol, 1-6 hexanediol, 1,5 hexanediol, 1-2-6-hexanetriol, 1-3-5-hexanetriol, sorbitol, isosorbide, and various derivatives thereof. Plasticizers may also include adipic acid and its derivatives, benzoic acid and its derivatives, citric acid and its derivatives, phosphoric acid and its derivatives, and urea. Other plasticizers are possible and this list is not exhaustive. The plasticizer is usually present in an amount ranging from 1 to 40%.

Thermoplastic starch may also be blended with another thermoplastics polymer or combination of thermoplastic polymers to improve water resistance, processability, or performance. The thermoplastic polymers may include but are not limited to polyolefins (low density polyethylene, linear-low density polyethylene, high density polyethylene, co-polymers of polyethylene, polypropylene, copolymers of polypropylene), polyesters, copolyesters, polyamides, co-polyamides, PBS, PHA, PLA, etc. The thermoplastic starch/thermoplastic blend may include a compatibilizer to improve the interaction of the two materials and facilitate processing and/or improve properties. Compatibilizers may include polar copolymers of polyethylene such as EVA, EAA, EMA, polyethylene-maleic anhydride, polypropylene maleic anhydride, etc.

It is also appreciated that other materials, especially including compatibilizing agents or polymers, can be used to enhance mechanical properties. Each layer can comprise between 0 and 15 volume percent of a compatibilizing agent. For example, olefinic block copolymers, styrenic block copolymers are typically used to compatibilized polyolefin and/or styrenics such as discussed by Lin in Journal of Applied Polymer Science, Vol 113, 1945-1952 (2009). For polylactic acid and polyolefin systems, compatibilization is possible using either block copolymers as disclosed in US Patent application 2012/0035323 A1 or reactive compatibilization as disclosed in US Patent application 2011/0195210 A1. A substantial difference in mechanical behavior is achieved by the amount of hard polymer, type of hard polymer, type of compatibilizer, or level of compatibilizer. A change in compatibilizer level of at least 3% within the layer can change the mechanical properties of the layer. It will be appreciated that the relative rheology of the matrix and immiscible hard polymer as well as the type of melt processing conditions can affect the shape of the included hard polymer and the degree of reinforcement as well as the degree of cavitation in any subsequent optional stretching operations. In certain embodiments, the viscosity ratio of the polymer matrix to the hard polymer can be from about 3:1 to about 1:3 as a suitable range for creating acceptable morphologies. Examples of suitable immiscible hard polymers are described in U.S. Pat. Nos. 4,377,616, 4,632,869, 5,264,548, 5,288,548 and 6,528,155.

In selecting a hard polymer it may be desirable to ensure that it will flow into structures, such as structures that will form reinforcing bodies within the matrix during melt processing. The hard polymer may be chosen to elongate during melt processing (formation of the film, for example, during a casting or blowing process) to create a high aspect ratio structures.

For a hard polymer that is an amorphous glassy polymer, the hard polymer is selected having a glass transition temperature below the processing temperature to ensure flow of the hard polymer in the molten processing state. It is also chosen to have a glass transition temperature above film use temperature. Therefore, for an amorphous hard polymer, the hard polymer may have a glass transition temperature between about 70° C. and about 230° C. For a hard polymer that is semi-crystalline polymer, the hard polymer is selected so that the melting point is lower than the processing temperature to ensure flow of the hard polymer in the molten processing state. For a semi-crystalline hard polymer, the hard polymer may have a melting point between about 70° C. and about 250° C.

Within this disclosure, hard polymers are immiscible within the matrix and may be further classified by their interface with the matrix, as characterized by interfacial strength, interfacial tension, or adhesion between the phases. Polymers within a same chemical class of polymers, e.g. polyolefins such as homopolymer propylene and linear low density polyethylene, act in a compatible manner at their interface with little or no microvoiding. Conversely, polymers from different chemical classes, e.g. polylactic acid and linear low density polyethylene, are both immiscible and void initiating. Micro-voiding between hard and matrix polymers may be confirmed when a film containing them is stretched 100% in the cross-machine direction (or CD) using ASTM D882. Void initiating hard polymers are defined as generating at least 5% higher opacity when the film containing them as inclusions is stretched 100% in the cross machine direction. This micro-voiding can also be observed microscopically by cross-sectioning the multi-layer film and examining the interface between the phases. Techniques such as atomic force microscopy are commonly used to examine phase structure and phase separation greater than 300 nanometers for 30 percent or more of the interfaces within a layer of the stretched film is anticipated to cause visible light scattering and higher opacity as defined above.

As used herein, the term “opacity” refers to the property of a substrate or printed substrate to hide or obscure from view an object placed behind the substrate relative to the point from which an observation is made. Opacity can be reported as the ratio, in percent, of the diffuse reflectance of a substrate backed by a black body having a reflectance of 0.5% to the diffuse reflectance of the same substrate backed by a white body having an absolute reflectance of 89%. The opacity referred to herein is measured as described in ASTM D 589-97, Standard Test Method for Opacity of Paper (15 Â°/Diffuse Illuminant A, 89% Reflectance Backing and Paper Backing). A substrate high in opacity will not permit much, if any, light to pass through the substrate. A substrate having low opacity will permit much, if not nearly all, light to pass through the substrate. Opacity can range from 0 to 100%. As used herein, the term “low opacity” refers to a substrate or printed substrate having opacity less than 50%. As used herein, the term “high opacity” refers to a substrate or printed substrate having opacity greater than or equal to 50%.

In certain embodiments, the concentration of the included hard polymer can vary between reinforcing layers. The volume percent of the included hard polymer in the “A” layer to the included hard polymer in the “B” layer may differ. In such cases, the ratio of the volume percent of the hard polymer in the “A” layer and the volume percent of the hard polymer in the “B” layer (or vice versa) may, for example, range from about 1:1.2 to about 1:5, alternatively from about 1:1.25 to about 1:4, or from about 1:1.5 to about 1:2. In such embodiments, the multi-layer polymeric film may display improved characteristics as a flat film and/or upon activation of the film as described herein. In certain embodiments, the amount of inclusion material (e.g., hard polymer) that can be added to a given layer for the film can range from about 5 volume percent to about 40 volume percent, alternatively from about 5 volume percent to about 30 volume percent, alternatively from about 8 volume percent to about 30 volume percent.

The multi-layer polymeric films can further include additional opacifying pigments. Such opacifying pigments generally have a different refractive index from the polymer matrix. For example, at least one of the “A” layer and the “B” layer can further include opacifying pigments. Such opacifying pigments can include zinc oxide, iron oxide, carbon black, aluminum, aluminum oxide, titanium dioxide, talc and combinations thereof. These opacifying pigments can comprise about 0.01% to about 10%, alternatively about 0.3% to about 7%, by volume of the multi-layer polymeric film. It will be appreciated that other suitable opacifying pigments may be employed and in various concentrations. Examples of opacifying pigments are described in U.S. Pat. 6,653,523.

Furthermore, the multi-layer polymeric films may comprise additional materials for any purpose (e.g., additives) in any layer of the film. as Additional materials may comprise other polymers (e.g., polypropylene, polyethylene, ethylene vinyl acetate, polymethylpentene, any combination thereof, or the like), minerals, processing aids, extenders, waxes, plasticizers, antiblocking agents, anti-oxidants, fillers (e.g., glass, talc, calcium carbonate, or the like), nucleation agents, mold release agents, flame retardants, electrically conductive agents, anti-static agents, pigments, impact modifiers, stabilizers (e.g., a UV absorber), wetting agents, dyes, or any combination thereof. Minerals can include without limitation calcium carbonate, magnesium carbonate, silica, aluminum oxide, zinc oxide, calcium sulfate, barium sulfate, sodium silicate, aluminum silicate, mica, clay, talc, and combinations thereof.

When there are differences between the adjacent layers, the multi-layer polymeric film may have improved properties relative to films having the same base material composition in adjacent layers. Such properties may include, for example one or more of the following: greater molecular orientation; higher opacities, higher tensile strength, higher tensile yield strength; higher permeability (to vapors and air); and better resistance to tear. However, it should be understood that such improved properties are not required to be present unless specified in the appended claims.

FIGS. 3 and 4 show a non-activated polymeric film with inclusion materials. The multi-layer polymeric film shown in FIGS. 3 and 4 has two alternating layers forming the film, wherein one layer includes an inclusion material of 40 wt. % (37 vol. %) polystyrene (100) in a 60 wt. % (63 vol. %) base LLDPE matrix, and the other layer includes an inclusion material of 10 wt. % (8.8 vol. %) polystyrene (100) in a 90 wt. % (91.2 vol. %) base LLDPE matrix. FIG. 3 shows the machine direction view, i.e. direction in which the film travels during processing. The cross section shows large and small body inclusions that are reflective of the relative concentrations within the layers. The inclusions in the film in FIGS. 3 and 4 exhibit a substantially uniform and repeating pattern where the layer with high polystyrene concentration is somewhat isolated by the layer with low polystyrene thus creating a relatively uniform distribution with minimized agglomeration of the minor phase (the hard polymers) within a layer or across layers. The same film viewed in the cross-machine direction of the multi-layer polymeric film is illustrated in FIG. 4. The inclusion polymer is extended and appears as fibrils and ribbons with high aspect ratios that are estimated between 2 and 100.

To achieve such improved and desired property characteristics, the multi-layer polymeric film may be stretched, drawn, or otherwise activated by mechanical deformation. Such stretching or activation of the multi-layer polymeric film can be achieved using ring roll stretching, machine direction orientation stretching (MDO), cross direction orientation (CDO), mechanical deformation, tenter framing or any combination thereof. Examples of such processes in which to activate the films are described in U.S. Pat. Nos. 3,241,662, 3,324,218, 3,832,267, 4,116,892, 4,153,751, 4,289,832, 4,704,238, 5,691,035, and 5,723,087; U.S. Patent Publication No. 2010/0055429 A1; European Patent and Patent Application Nos. EP 963292 A1, EP 1007329 Al, and EP 1803772 B1.

In one embodiment the multi-layer polymeric film is subject to less than about 50% stretching, and in another embodiment, the multi-layer polymeric film is subject to stretching between about 10% to about 30%. It will be appreciated that a variety of suitable stretching techniques can be used to activate the multi-layer polymeric film, such as a combination of machine direction orientation, cross direction orientation and annealing. One such combination is described in U.S. Pat. No. 7,442,332. Further, it may be desired to activate the multi-layer polymeric film multiple times in order to achieve optimum results relating to improved property characteristics. The activation of the multi-layer film may, in some cases, increases the opacity by at least 5% while decreasing the basis weight by at least 20% from the basis weight of the unactivated multi-layer film. For example, manufacturing multi-layer polymeric films and stretching said films to a basis weight of less than about 15 gsm and containing less than about 7 wt. percent of expensive light scattering titanium dioxide can provide a film having an opacity of at least 60%; and in certain embodiments, an opacity of at least 70%.

The multi-layer polymeric film described herein can be utilized in a variety of alternative applications, including, but not limited to, personal care absorbent products such as diapers, training pants, incontinence garments, sanitary napkins, and other hygiene articles, bandages, wipes and the like, as well as products such as packaging materials, and other disposable products such as trash bags and food bags. For example, the multi-layer polymeric film may be useful as a liquid impervious backsheet and/or barrier cuff on a disposable absorbent article. In one such application the multi-layer polymeric film can be used as a hygiene film. For example, such a hygiene film can have at least two layers of each of “A” layer and “B” layer that are formed in a repeating pattern and the thickness of each respective layer can be less than about 2 micrometers. As described herein, the multi-layer polymer films can join with other films to form a laminate arrangement. Thus, it will be appreciated that in certain embodiments, a hygiene film (such as the one described herein) can be joined with a nonwoven material to form a laminate structure, particularly one that can be used in hygiene related applications.

The aforementioned multi-layer polymeric films may be prepared by any suitable method. For cast films one method can include employing a high output, high speed cast extrusion line using multiple extruders. The processing conditions will depend upon the materials being used, the processing equipment and the desired film properties. The multi-layer films described herein can also be formed from conventional simple blown film or cast extrusion techniques as well as by using more elaborate techniques such a “tenter framing” process. The present disclosure further relates to a method for making the layered arrangement for a multi-layer polymeric film. Multi-layer polymeric films can be made by known coextrusion processes typically using a flat cast or planar sheet or annular blown film process. Coextruded cast film or sheet structures typically have 3 to 5 layers; however, cast film or sheet structures including hundreds of layers are known. In one method for making a multi-layer film, the number of layers may be multiplied by the use of a device as described in U.S. Pat. No. 3,759,647. Other methods are further described in U.S. Pat. Nos. 5,094,788 and 6,413,595. Here, a first stream comprising discrete, overlapping layers of the one or more materials is divided into a plurality of branch streams, these branch streams are redirected or repositioned and individually symmetrically expanded and contracted, the resistance to flow through the apparatus and thus the flow rates of each of the branch streams are independently adjusted, and the branch streams recombined in overlapping relationship to form a second stream having a greater number of discrete, overlapping layers of the one or more materials distributed in the prescribed gradient or other distribution. In certain embodiments, thin layers can be formed on spiral channel plates and these layers can flow into the central annular channel where micro-layer after micro-layer can then be stacked inside traditional thick layers. Such examples are described in U.S. Patent Publication No. US 2010/0072655 A1. A plurality of layers may be made in blown films by various methods. In US 2010/0072655 A1, two or more incoming streams are split and introduced in annular fashion into a channel with alternating plurality of microlayers that are surrounded by standard layer polymeric streams to form blown films containing microlayer regions. For annular dies, a known microlayer process for creating a plurality of alternating layers is made by distributing the flow of the first polymer stream into every odd internal microlayer layer and distributing the flow of the second polymer stream into every even microlayer. This microlayer group is then introduced between channels of polymer streams of standard thickness. Layer multiplication technology for cast films is marketed by companies such as Extrusion Dies Industries, Inc. of Chippewa Falls, Wis. and Cloeren Inc. of Orange, Tex. Microlayer and nanolayer technology for blown films is marketed by BBS Corporation of Simpsonville, S.C.

For example, early multi-layer processes and structures are shown in U.S. Pat. Nos. 3,565,985; 3,557,265; and 3,884,606. PCT Publication WO 2008/008875 discloses a method of forming alternative types of multi-layered structures having many, for example fifty to several hundred, alternating layers of foam and film.

Other manufacturing options include simple blown film (bubble) processes, as described, for example, in The Encyclopedia of Chemical Technology, Kirk-Othmer, Third Edition, John Wiley & Sons, New York, 1981, Vol. 16, pp. 416-417 and Vol. 18, pp. 191-192. Processes for manufacturing biaxially oriented film such as the “double bubble” process described in U.S. Pat. No. 3,456,044 (Pahlke), and other suitable processes for preparing biaxially stretched or oriented film are described in U.S. Pat. No. 4,865,902 (Golike et al.); U.S. Pat. No. 4,352,849 (Mueller); U.S. Pat. No. 4,820,557 (Warren); U.S. Pat. No. 4,927,708 (Herran et al.); U.S. Pat. No. 4,963,419 (Lustig et al.); and U.S. Pat. No. 4,952,451 (Mueller). The film structures can also be made as described in a tenter-frame technique, such as that used for oriented polypropylene.

Other multi-layer polymeric film manufacturing techniques for food packaging applications are described in Packaging Foods With Plastics, by Wilmer A. Jenkins and James P. Harrington (1991), pp. 19-27, and in “Coextrusion Basics” by Thomas I. Butler, Film Extrusion Manual: Process, Materials, Properties pp. 1-80 (published by TAPPI Press (1992)).

The multi-layer polymeric films can be laminated onto another layer(s) in a secondary operation, such as that described in Packaging Foods With Plastics, by Wilmer A. Jenkins and James P. Harrington (1991) or that described in “Coextrusion For Barrier Packaging” by W. J. Schrenk and C. R. Finch, Society of Plastics Engineers RETEC Proceedings, Jun. 15-17 (1981), pp. 211-229. If a monolayer film layer is produced via tubular film (i.e., blown film techniques) or flat die (i.e., cast film) as described by K. R. Osborn and W. A. Jenkins in “Plastic Films, Technology and Packaging Applications” (Technomic Publishing Co., Inc. (1992)), then the film must go through an additional post-extrusion step of adhesive or extrusion lamination to other packaging material layers to form a multilayer film. If the film is a coextrusion of two or more layers (also described by Osborn and Jenkins), the film may still be laminated to additional layers of packaging materials, depending on the other physical requirements of the final film. “Laminations vs. Coextrusion” by D. Dumbleton (Converting Magazine (September 1992), also discusses lamination versus coextrusion. The multi-layer polymeric films contemplated herein can also go through other post extrusion techniques, such as a biaxial orientation process.

### EXAMPLES

Several multilayer films are created as five or thirty-five layer films. These films either use polylactic acid (PLA) or high impact polystyrene (HIPS) as the reinforcing material. The skin layer is formulated with 65 wt. % DOWLEX™ 2047G LLDPE sold by Dow Chemical Co., Midland, Mich. U.S.A., 15 wt. % LD117 LDPE sold by ExxonMobil, Inc. of Irving, Tex. USA, and 20 wt. % DOWLEX™ 2036G MDPE. Minor amounts of antiblock and anti-oxidant are added. The reinforcing material for Sample ID's 1-5 and 8-9 is polylactic acid, INGEO™ 4042D sold by NatureWorks, LLC of Minnetonka, Minn. USA and for Sample ID's 6-7 is high impact polystyrene, HIPS 473D sold by Ineos of Lausanne, Switzerland. A compatibilizer for PLA, LOTADER TX8030 sold by Arkema Inc. of King of Prussia, Pa. USA, is used for PLA formulations. The formulas are outlined in the table below:

TABLE 1
Formulas for Reinforced Films

| | | | | | COMPOSITION A | | | |
|---|---|---|---|---|---|---|---|---|
| | | | | | Dowlex | LDPE | Dowlex | Hard |
| | No. | Skin | A layer | B layer | 2047G | LD117.85 | 2036G | Polymer |
| ID | Layers | Thickness | Thickness | Thickness | (wt. %) | (wt. %) | (wt. %) | (wt. %) |
| 1 | 35 | 20% | 40% | 40% | 65% | 15% | 20% | 0% |
| 2 | 35 | 40% | 40% | 20% | 59% | 14% | 18% | 8% |
| 3 | 35 | 20% | 40% | 40% | 59% | 14% | 18% | 8% |
| 4 | 35 | 40% | 20% | 40% | 59% | 14% | 18% | 8% |
| 5 | 35 | 40% | 20% | 40% | 52% | 12% | 16% | 16% |
| 6 | 35 | 40% | 40% | 20% | 54% | 17% | 13% | 17% |
| 7 | 5 | 40% | 40% | 20% | 54% | 17% | 13% | 17% |
| 8 | 5 | 20% | 40% | 40% | 53% | 14% | 18% | 8% |
| 9 | 5 | 40% | 20% | 40% | 59% | 14% | 18% | 8% |

| | COMPOSITION A | | COMPOSITION B | | | | | |
|---|---|---|---|---|---|---|---|---|
| | Hard | Lotader | Dowlex | LDPE | Dowlex | Hard | Hard | Lotader |
| | Polymer | TX8030 | 2047G | LD117.85 | 2036G | Polymer | Polymer | TX8030 |
| ID | (vol. %) | (wt. %) | (wt. %) | (wt. %) | (wt. %) | (wt. %) | (vol. %) | (wt. %) |
| 1 | 0% | 0% | 65% | 15% | 20% | 0% | 0% | 0% |
| 2 | 6% | 1% | 42% | 12% | 16% | 16% | 12% | 2% |
| 3 | 6% | 1% | 42% | 12% | 16% | 16% | 12% | 2% |
| 4 | 6% | 1% | 53% | 14% | 18% | 8% | 6% | 1% |
| 5 | 12% | 2% | 30% | 11% | 14% | 24% | 19% | 3% |
| 6 | 15% | 0% | 21% | 7% | 5% | 67% | 64% | 0% |
| 7 | 15% | 0% | 21% | 7% | 5% | 67% | 64% | 0% |
| 8 | 6% | 1% | 42% | 12% | 16% | 16% | 12% | 2% |
| 9 | 6% | 1% | 53% | 14% | 18% | 8% | 6% | 1% |

The films in Table 1 are tested for basis weight, tensile properties, tear properties, and web modulus. These properties are measured using known analytical techniques. Tensile tests are conducted using ASTM method D882. Elmendorf tear tests are conducted using ASTM D1922. Trapezoidal (Trap) tear tests are conducted using ASTM D5733. The web modulus is measured using a large 610 by 150 mm section of film that is rolled, flatted, and tested in tensile deformation as disclosed in US Patent Application 2003/0105443A1 (Ohnishi et. al.). The results are exhibited in Table 2. A control (100) film is listed in the first row. The tensile strength of the experimental films is higher than that of the control film, and the web modulus is significantly higher.

TABLE 2
Mechanical Properties of Multi-layer Reinforced Films.

| | | CD | | CD % | CD | MD | | MD % | MD | CD | CD | MD | MD | Web |
|---|---|---|---|---|---|---|---|---|---|---|---|---|---|---|
| For- | Ba- | Tensile | CD % | Elonga- | Load | Tensile | MD % | Elonga- | Load | Trap | Trap | Trap | Trap | Modulus |
| mula | sis | At Peak | Strain | tion at | at yield | At Peak | Strain | tion at | at yield | Tear | Tear Avg | Tear | Tear Avg | at 2% |
| Code | Wt | N/cm | At Peak | Yield | N | N/cm | At Peak | Yield | N | Force N | Load N | Force N | Load N | N/cm |
| 1 | 10.8 | 1.166 | 310.706 | 11.882 | 0.9 | 2.152 | 348.906 | 74.52 | 1.638 | 6.364 | 3.612 | 4.324 | 2.246 | 14.994 |
| 2 | 10.2 | 1.25 | 328 | 7.52 | 0.99 | 2.68 | 381.05 | 72.53 | 1.81 | 7.60 | 4.476 | 2.234 | 0.8 | 25.87 |
| 3 | 10.9 | 1.71 | 511 | 7.62 | 1.04 | 3.01 | 410.86 | 43.24 | 1.51 | 8.45 | 4.708 | 2.584 | 1.35 | 47.978 |
| 4 | 10.5 | 1.95 | 526 | 11.71 | 1.07 | 2.90 | 365.02 | 70.18 | 1.87 | 7.43 | 4.184 | 2.612 | 1.218 | 25.616 |
| 5 | 10.9 | 1.66 | 523 | 6.72 | 1.03 | 2.97 | 336.62 | 65.16 | 1.78 | 7.77 | 4.258 | 2.334 | 1.146 | 41.058 |
| 6 | 10.3 | 1.67 | 459 | 391.90 | 1.57 | 2.82 | 90.01 | 68.09 | 2.62 | 9.89 | 5.544 | 1.74 | 0.78 | 49.98 |
| 7 | 10.2 | 1.52 | 436 | 435.97 | 1.52 | 2.61 | 174.63 | 174.63 | 2.61 | 7.24 | 3.926 | 2.664 | 1.114 | 41.282 |
| 8 | 10.1 | 1.28 | 160 | 3.77 | 0.83 | 3.75 | 334.28 | 68.00 | 2.57 | 6.91 | 3.714 | 1.76 | 0.764 | 43.956 |
| 9 | 10.4 | 2.30 | 563 | 10.69 | 1.16 | 3.17 | 285.92 | 68.12 | 2.28 | 7.68 | 4.202 | 2.5 | 1.234 | 27.248 |

### Example 2

Biologically sourced LLDPE from Braskem of Sao Paulo, SP Brasil is used in lieu of petroleum based LLDPE. A thirty-five layer film with the same composition as ID 3 in Example 1. For this film, the DOWLEX 2047G is replaced with the BRASKEM SLH218. The resulting film is tested as in Example 1. The results are shown in Table 2.

TABLE 3
Mechanical Properties of Multi-layer Reinforced Films Made with BRASKEM Bio-LLDPE.

| | | CD | | CD % | | MD | | MD % | | | | MD | MD | Web |
|---|---|---|---|---|---|---|---|---|---|---|---|---|---|---|
| | Basis | Tensile | CD % | Elonga- | CD Load | Tensile | MD % | Elonga- | MD Load | CD Trap | CD Trap | Trap | Trap | Modulus |
| | Wt | At Peak | Strain | tion | at yield | At Peak | Strain | tion at | at yield | Tear | Tear Avg | Tear | Tear Avg | at 2% |
| ID | (gsm) | N/cm | At Peak | at Yield | N | N/cm | At Peak | Yield | N | Force N | Load N | Force N | Load N | N/cm |
| 10 | 9.3 | 1.79 | 359.188 | 12.486 | 1.458 | 1.94 | 317.788 | 69.436 | 1.56 | 6.816 | 3.71 | 3.396 | 1.666 | 30.33 |

### Example 3

A five layer film is made with two skin layers (S), two internal reinforcing layers (A), and one additional internal reinforcing layer (B). The layer composition is shown in Table 4 where polypropylene impact copolymer (an immiscible, non-voiding hard polymer) is added to the A layer for reinforcement and polylactic acid with LOTADER™ compatibilizer is added to the B layer for reinforcement.

TABLE 4
Example 3 Layer Composition

| | PE918 | | PE935 | | | | TiO2 MB |
|---|---|---|---|---|---|---|---|
| | DOWLEX | LDPE | DOWLEX | Pro Fax | LOTADER ™ | PLA | Ampacet |
| Layer | 2047G | 5004I | 2036G | 7624 | TX8030 | 4042 | 110313-C |
| S | 65% | 15% | 20% | 0% | 0% | 0% | 0% |
| A | 48% | 15% | 15% | 17% | 0% | 0% | 5% |
| B | 51% | 15% | 16% | 0% | 1% | 12% | 5% |

The resulting film exhibits good mechanical strength in both the machine direction and cross direction of the film. The advantage of this system is that properties in machine and cross directions can be tailored by suitable adjustment of the reinforcing components. The polypropylene increases strength in both directions while the polylactic acid greatly increases modulus in the machine direction.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited in the Detailed Description are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multi-layer polymeric film having a thickness, said film comprising:
a) at least one polymeric skin layer;
b) a polymeric “A” layer joined at least indirectly to said skin layer, said “A” layer having a thickness and comprising a first composition comprising a first base polymer matrix and about 5 to about 40 volume percent of a hard polymer substantially disposed therein to form a structure in said polymer matrix; and
c) a polymeric “B” layer joined to said “A” layer, said “B” layer having a thickness and comprising a second composition comprising a second base polymer matrix and about 5 to about 40 volume percent of a hard polymer substantially disposed therein, wherein at least one of the hard polymers in the “A” layer and the “B” layer is immiscible and void initiating when the film is stretched, and the “A” layer and the “B” layer are adjacent and differ in at least one of the following:
i) the first base polymer and the second base polymer differ;
ii) volumetric concentration of said hard polymer differ;
iii) wherein at least one of said “A” layer and said “B” layer comprises a compatabilizer, and said “A” and “B” layers differ in the level or type of compatabilizer; and
iv) layer thickness differ by at least about 20%, and
wherein the at least one skin layer has a thickness, or total thickness, if more than one, that is from about 20 to about 60% of the thickness of the multi-layer polymeric film.

2. The multi-layer polymeric film of claim 1, wherein each of the first base polymer and the second base polymer is selected from the group consisting of: polyolefins, polypropylene, low density polyethylene, linear lower density polyethylene, linear medium density polyethylene, high density polyethylene, polypropylene-ethylene interpolymer, polyhydroxyalkanoates, post consumer recycled polyolefins, and mixtures thereof.

3. The multi-layer polymeric film of claim 1 wherein said at least one polymeric skin layer, said first base polymer, and said second base polymer, each comprise a polyolefin.

4. The multi-layer polymeric film of claim 1, wherein the film comprises a bio-based content of about 10% to about 100% using ASTM D6866-10, method B.

5. The multi-layer polymeric film of claim 1, wherein the first base polymer and the second base polymer are the same.

6. The multi-layer polymeric film of claim 1, wherein the first base polymer and the second base polymer are different polymers.

7. The multi-layer polymeric film of claim 1, wherein at least one of the first composition and the second composition has a compatabilizer therein, and any compatabilizers in the first composition and the second composition differ in amount by at least about 3%, or in type of compatabilizer.

8. The multi-layer polymeric film of claim 1, wherein the hard polymer with void initiating properties is selected from the group consisting of: polystyrene, high impact polystyrene, polybutylene terephthalate, polytrimethylene terephthalate, polycarbonate, polylactic acid, polymethyl methacrylate, cellulose acetate, and polyhydroxyalkanoates so long as the base polymer is not also a polyhydroxyalkanoate, and combinations thereof.

9. The multi-layer polymeric film of claim 8, wherein the hard polymer is polystyrene or polylactic acid.

10. The multi-layer polymeric film of claim 1, wherein the hard polymers in both the “A” layer and the “B” layer are immiscible and void initiating when the film is stretched.

11. The multi-layer polymeric film of claim 1, wherein the polymeric “A” layer and the polymeric “B” layer each have a thickness of greater than or equal to about 50 nanometers to less than or equal to about 12 micrometers.

12. The multi-layer polymeric film of claim 1, wherein the polymeric “A” layer and the polymeric “B” layer differ in thickness by a ratio between about 1:1.2 to 1:5.

13. The multi-layer polymeric film of claim 1, wherein volumetric concentration of said hard polymer in the polymeric “A” layer and the polymeric “B” layer differ by a ratio between about 1:1.2 to 1:5.

14. The multi-layer polymeric film of claim 1, wherein the total amount of said hard polymer in said multi-layer polymeric film is from about 5%-15% by volume of the multi-layer polymeric film.

15. The multi-layer polymeric film of claim 1, wherein further comprising a second polymeric skin layer joined at least indirectly to said “B” layer so that said “A” and “B” layers are in between said first and second skin layers.

16. The multi-layer polymeric film of claim 1, comprising at least four layers including said skin layer, said “A” layer, and said “B” layer, and at least one additional “A” layer or “B” layer arranged so that said “A” layers and “B” layers alternate.

17. The multi-layer polymeric film of claim 16 having two outer surfaces, said multi-layer film further comprising a second polymeric skin layer, wherein said skin layers are joined to one of the A and B layers to form both outer surfaces of said multi-layer polymeric film.

18. The multi-layer polymeric film of claim 1 wherein the combined thickness of all polymeric “A” layers and all polymeric “B” layers is at least 40% of the total thickness of the multi-layer polymeric film.

19. The multi-layer polymeric film of claim 1 having a total thickness that is between about 4 to about 100 micrometers.

20. A method of forming a multi-layer polymeric film, the method comprising:
a) preparing a first composition, the first composition comprising a first base polymer having an elastic modulus and a first hard polymer, the first hard polymer being immiscible in the first base polymer, wherein the first material has a higher elastic modulus than the first base polymer;
b) preparing a second composition, the second composition comprising a second base polymer having an elastic modulus and a second hard polymer, the second hard polymer having a higher elastic modulus than the second base polymer, and being immiscible in the second base polymer after being formed into a layer, wherein least one of the hard polymers in the “A” layer and the “B” layer void initiating when the film is stretched;
c) preparing a third composition comprising a polymer, which is substantially free of hard polymers; and
d) coextruding the first, second and third compositions into a structure in which the first and second compositions form adjacent layers, and the third composition forms a skin layer forming one of the outer surfaces of the multi-layer polymeric film wherein “A” layer and the “B” layer are adjacent and differ in at least one of the following:
i) the first base polymer and the second base polymer differ;
ii) volumetric concentration of said hard polymer differ;
iii) wherein at least one of said “A” layer and said “B” layer comprises a compatabilizer, and said “A” and “B” layers differ in the level or type of compatabilizer; and
iv) layer thickness differ by at least about 20%, and
wherein the at least one skin layer has a thickness, or total thickness, if more than one, that is from about 20 to about 60% of the thickness of the multi-layer polymeric film.

21. The method of forming a multi-layer polymeric film of claim 20 further comprising a step e) of stretching the coextruded multi-layer polymeric film.
